(19) United States
(12) Patent Application Publication
(10) Pub. No.: US 2007/0143475 A1
(43) Pub. Date: Jun. 21, 2007

(54) Identification services

(76) Inventor: Brian Daigle, Marietta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/304,288

(22) Filed: Dec. 15, 2005

(51) Int. Cl. G06F 15/173

(52) U.S. Cl. 709/225

(57) ABSTRACT

One embodiment of the present disclosure provides a method for verifying information about an entity. In this regard, one embodiment of such a method, among others, can be broadly summarized by the following steps: receiving a request to release independently verified information about the entity, the entity being identified by a pseudonym in the request; checking whether the entity authorizes release of the verified information identified in the request to a party originating the request; and releasing the verified information to the party if the entity authorizes release of the verified information identified in the request to the party originating the request. Other methods and devices are also provided.

### TECHNICAL FIELD

The present disclosure is generally related to network communications and, more particularly, is related to validating network entities.

### BACKGROUND

In many forms of Internet communications, parties involved in the communication are anonymous. For example, in an e-mail message, an e-mail address does not necessarily reveal a lot about the person who wrote the message.

During an instant messaging session, a screen name of a party does not necessarily reveal or identify the person responsible for an instant message. In many of these types of communications, a party is not able to see or hear the party on the other end of a line of communication. Therefore, it is hard to establish a trust in believing the identity of a communication partner. Further, it is known that intentional misidentifications are made by some people to mislead other persons and commit fraud. This can be a problematic situation especially in situations where a central directory may publish an instant messaging identifier or some other type of identifier or address to others users that are not necessarily known to a holder of a published instant messaging identifier.

Thus, a heretofore unaddressed need exists in the industry to address the aforementioned deficiencies and inadequacies.

### SUMMARY

Embodiments of the present disclosure provide systems, methods, and devices for verifying information about an entity. In this regard, one embodiment of such a method, among others, can be broadly summarized by the following steps: receiving a request to release independently verified information about the entity, the entity being identified by a pseudonym in the request; checking whether the entity authorizes release of the verified information identified in the request to a party originating the request; and releasing the verified information that is authorized by the entity to the party if the entity authorizes release of the verified information identified in the request to the party originating the request.

Embodiments also include a computer readable medium having a computer program for performing the above steps. Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment of an Internet identification system of the present disclosure.

FIGS. 2-4 are diagram representations of embodiments of an interface to an instant messaging application utilized within the system of FIG. 1.

FIGS. 5-6 are diagram representations of an embodiment of a web browser interface displaying a registration web page utilized within the system of FIG. 1.

FIGS. 7-9 are diagram representations of embodiments of a web browser interface displaying web pages employing the identification service of the present disclosure.

FIG. 10 is a diagram of a flow of interactions between the identification server and database system and client devices of FIG. 1 according to an exemplary embodiment.

FIG. 11 is a flow chart describing one embodiment of a method for verifying information about an entity as utilized within the system of FIG. 1;

FIG. 12 is a flow chart describing one embodiment of a method for verifying information about an entity as utilized within the system of FIG. 1; and

FIG. 13 is a block diagram of a computer that can implement components of the system of FIG. 1 according to an exemplary embodiment.

### DETAILED DESCRIPTION

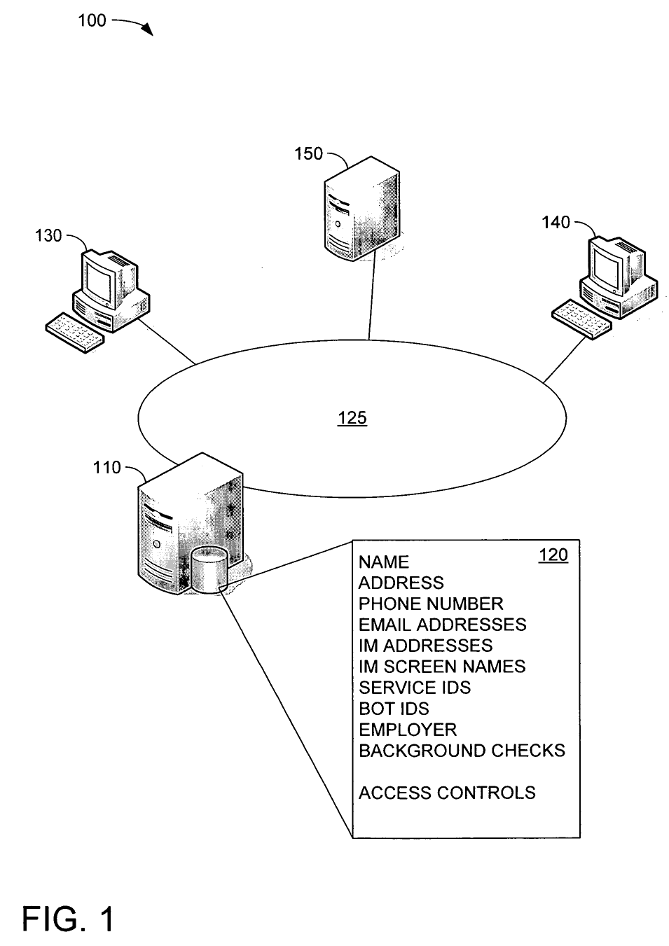

FIG. 1 is a block diagram of one embodiment of an Internet identification system of the present disclosure. An identity server and database system 110 is provided that stores identification records, such as identification record 120, of members of an Internet identification system 100. An identification record 120 contains sets of information that may be used to identify and ascertain the identity of a member of the system by authorized users. For example, in one embodiment, an identification record 120 may contain a member's full name, the street address, phone number(s), e-mail address(es), instant messaging identifier(s), instant messaging screen names, service identifier(s) (IDs), Bot IDs, Employer information, or background check information, based on the applicability of the information for the particular member. For example, a web server may be configured to respond and communicate to actions performed by a user on a merchant's web site. Accordingly, a user may want to ascertain that the party to whom he or she is responding is either a real person or a web server. Accordingly, an identification record for the web server may have a server ID or a Bot ID that is provided or able to obtained by a user that can be used to retrieve information about the web server or program implementing a communication response. This information may be provided to an interested and authorized user to verify the identity of the web server or computer program (such as a computer program that imitates a human person (e.g., an instant messaging robot or. “IM Bot”)).

Also, as shown in the identification record 120, access controls may be specified. For example, a member may specify other persons, organizations, or groups of persons that are authorized to access his or her personal information that is maintained by the identification server and database system 110. Such persons or entities may be identified by a unique identifier or pseudonym, such as instant messaging identifiers, screen names, user IDs, e-mail addresses, etc. Therefore, a person who provides such an identifier is acknowledged to have been pre-authorized by the member to have access to personal information maintained on the identification server and database system 110.

In one embodiment, for a person to establish an identification record, an identification service (not shown) operating the identification server and database system 110 requests one or two forms of national identification, such as a passport ID with a photo or a social security card. Alternatively, the service may accept a state ID, such as a driver's license or a state issued identification card. Further, the service may request proof of a current residential address such as that provided on a recent utility bill. Forms of proof are not limited to the examples above. For example, a variety of documents may be used to verify the identity of a person, including a credit report by a credit bureau.

Referring back to FIG. 1 and an illustrative example, two parties may be involved in communication over a network 125, such as the Internet. One of the parties utilizes a client device 130 to communicate with a client device 140 of the other party. The client devices may include, for example, personal computers, laptops, personal digital assistants, wireless communication devices, etc. Although only two client devices are shown in FIG. 1 for ease of illustration, it will be appreciated than any number of client devices may be used in accordance with exemplary embodiments.

For instance, the two parties may be involved in e-mail communication, video chat, a web forum discussion, a web-based chat launched from a web site, etc.

Generally, the Internet identification system is suited for these types of communication and any situation where the identification of another person is desired to be verified.

For the sake of present example, it is assumed that the two parties are involved in an instant messaging session. Accordingly, in FIG. 1, the instant messaging session is facilitated by an instant messaging server 150.

One of the parties is referred by his or her screen name “GTFan13” and the other party is referred by his or her screen name “FREDDYK.” In this example, FREDDYK obtained the instant messaging identifier and screen name of GTFan13 from a central instant messaging directory. Therefore, GTFan13 has no personal knowledge of FREDDYK. However, in a brief chat session with FREDDYK, GTFan13 believes that he has a lot in common with FREDDYK including a love of cars. In fact, FREDDYK offered to sell a car to GTFanl3, but GTFan13 would like to verify for sure that FREDDYK is who he says that he is during their instant messaging chats.

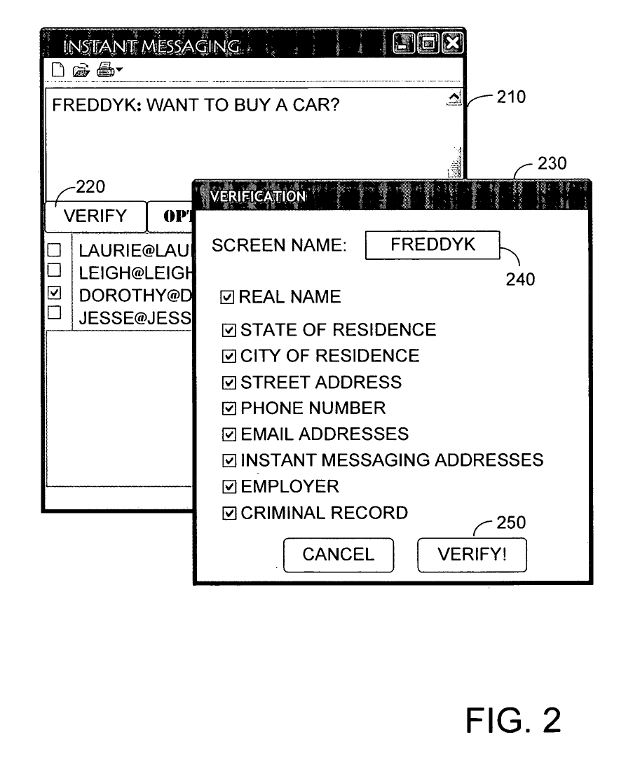

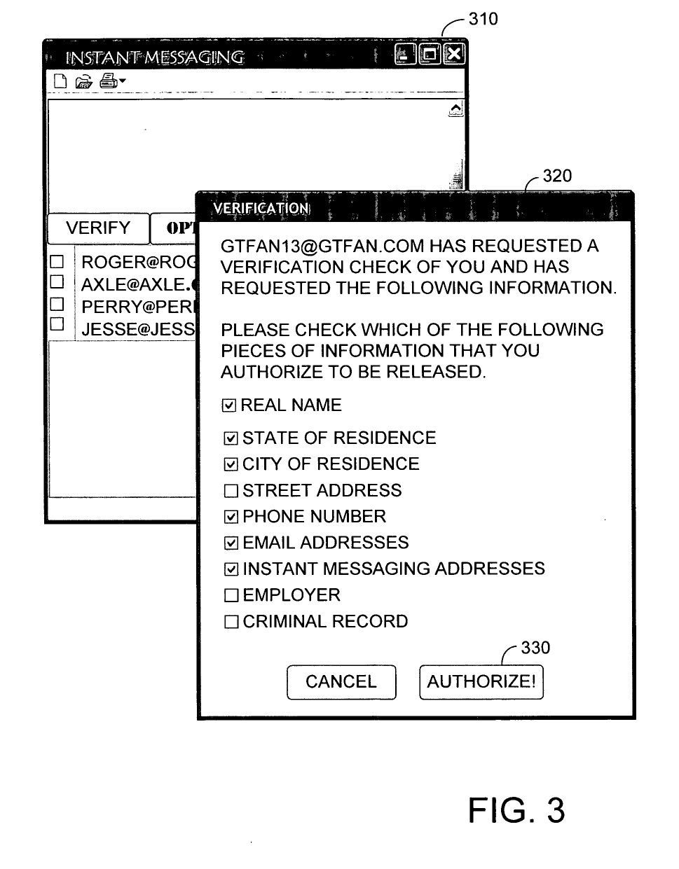

Therefore, in one embodiment, an instant messaging application may provide a mechanism for verifying the identity of a person. To illustrate, FIG. 2 displays an embodiment of an interface to an instant messaging application. As shown, an instant messaging chat window 210 includes a graphical VERIFY button 220 that may be selected by a user. Upon selection of the VERIFY button, a new window 230 may be opened on a desktop of a client device 130. This window 230 may provide input box 240 for entering a screen name of another instant messaging user. In this example, GTFan13 provides the screen name of FREDDYK in the box 240.

Also, a user may be able to check a checkbox next to an item of interest that the user would like to learn about the instant messaging user identified by the screen name provided in box 240. In the example shown, GTFan13 desires to obtain information directed to the real name, state of residence, city of residence, street address, phone number, e-mail addresses, instant messaging identifiers, employer information, and criminal record information of FREDDYK. Accordingly, by pressing the VERIFY! button 250, a request is sent to the identification server and database system 110 to look up a record of a person with the screen name FREDDYK on behalf of a requesting party.

If the identification server and database system 110 does have a record for FREDDYK, a message is sent to the instant messaging client of FREDDYK so that FREDDYK can authorize the requesting party to obtain information about his or her identity. If FREDDYK does not happen to be online to provide his or her permission for release of the requested information, the information is not released, unless FREDDYK has previously agreed for the identification service to release information without requiring his or her further consent. For example, within his or her identification record 120, FREDDYK may identify persons or groups that are authorized to access his or her information on demand. These designations are generally regarded as access controls.

Assuming that FREDDYK is online and he/she prefers to selectively decide who has access to his or her identification information, the message sent by the identification server and database system 110 to the instant messaging client (such as a client device 130, 140 in an exemplary embodiment) causes an instant messaging chat window 310 to launch a new window 320 prompting FREDDYK that GTFan13 has requested a verification check, where certain information has been requested. The verification window 320 lists each of the items and allows a user, such as FREDDYK, to choose which of the items are to be released to the requesting user. In the present case, FREDDYK has agreed to release information directed towards his real name, state of residence, phone number, e-mail addresses, and instant messaging identifier. Correspondingly, FREDDYK has denied release of information directed towards his or her street address, employer information, and criminal record information. After the items are selected, authorization of the release of the items are sent to the identification server and database system 110 by selecting the AUTHORIZE button 330 on the verification window 320.

Also note that FREDDYK, in some circumstances, may also request verification of the identification of the party that has requested information about him or her. This sort of quid pro quo arrangement is contemplated by the present disclosure.

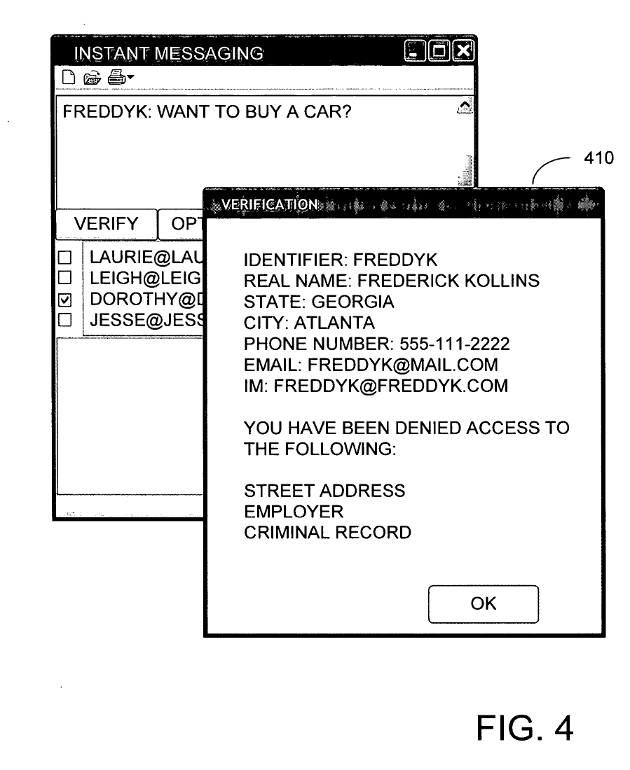

On receipt of the authorization, the identification service obtains the requested information from the identification record of FREDDYK and returns the information to the requesting user, GTFan13. In one embodiment, the requesting user may receive the information within a window interface, such as that shown in FIG. 4. Here, the window interface 410 lists the information requested by the user. The requesting user is able to view information about another person that has been independently verified by the identification service. Further, the requesting user is notified of which items of interest that he or she is not allowed to access.

In this way, items of information may be obtained that are useful in identifying another person and also building a level of trust in Internet communications, where a certain level of suspicion generally exists. Accordingly, embodiments of the present disclosure help facilitate Internet transactions.

For example, before the subject of Internet communications between two parties becomes significantly serious or turns towards certain items, the parties may desire to verify the identity or pertinent information about each other. The identification service may display any information that an entity has authorized another entity to view. Also, sensitive information can still be protected within the identification database but be used to authenticate the identity of an entity.

After a member of the service is authenticated (via national forms of IDs, state IDs, etc.), then additional information such as phone numbers, instant messaging identifiers, address information, bio information, etc. is used to populate a member's identification record and may be key in identifying the qualities or characteristics of the member to a requesting user and verifying that a person is who he or she says he/she is in communications with the user.

The identification server and database system 110 may provide a national service accessible from a public network, such as the Internet 125. Alternatively, in some embodiments, the service may be provided within a private network, such as an enterprise network of a company or corporation.

As a member of the identification service, a person may have decided to join the service because the person was and is interested in performing transactions over the Internet, such as general communications or purchases. A transaction partner is able to use the identification service to verify that the member is who he/she says he/she is and the partner can have confidence that the phone number, address, etc. provided by the member is genuine.

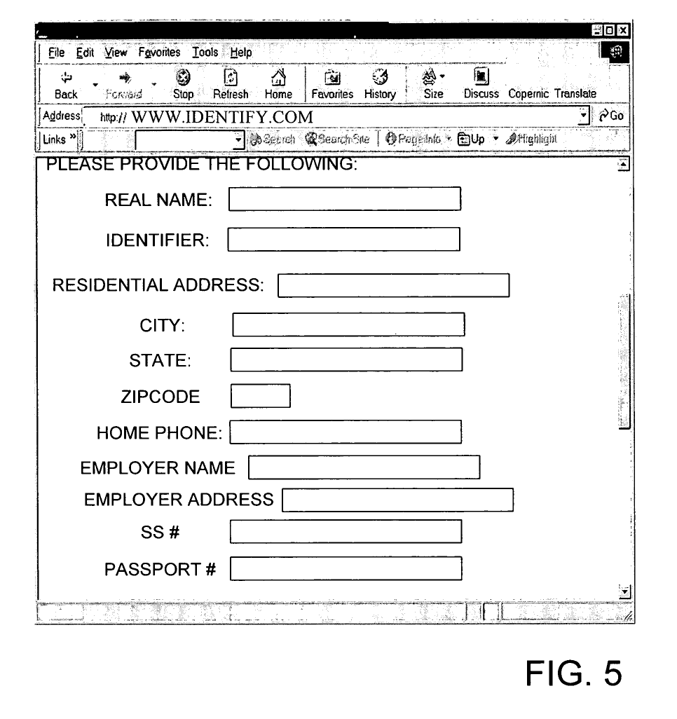

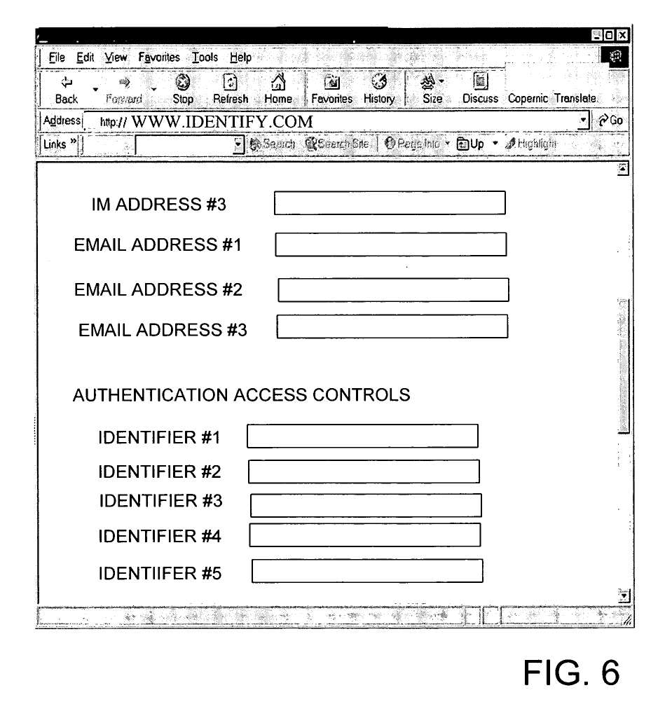

In one embodiment, a user may register for the identification service via a web site for the service. As part of the registration process, the user may provide biographical information about himself or herself that may either individually or collectively uniquely identify the user from other users. FIGS. 5-6 show a portion of an exemplary registration web page being displayed within a web browser interface. In the example of FIG. 5, the user is requested to provide his or her real name, an identifier (such as a screen name), residential address, city, state, zip code, home phone, employer name and address, social security number, and passport number. In another portion of the registration web page, as shown in FIG. 6, the user is also prompted to provide instant messaging identifiers, e-mail addresses, and access control identifiers, such as unique identifiers for groups, organizations, individuals, e-mail addresses, and pseudonyms (as described above) of persons that are authorized to access the user's information. In some embodiments, the administrators of the Internet identity system may also require that the user send documentation (e.g., a copy of an income tax return, passport, or phone bill)for example by e-mail or mail—sufficient to verify the information the user entered.

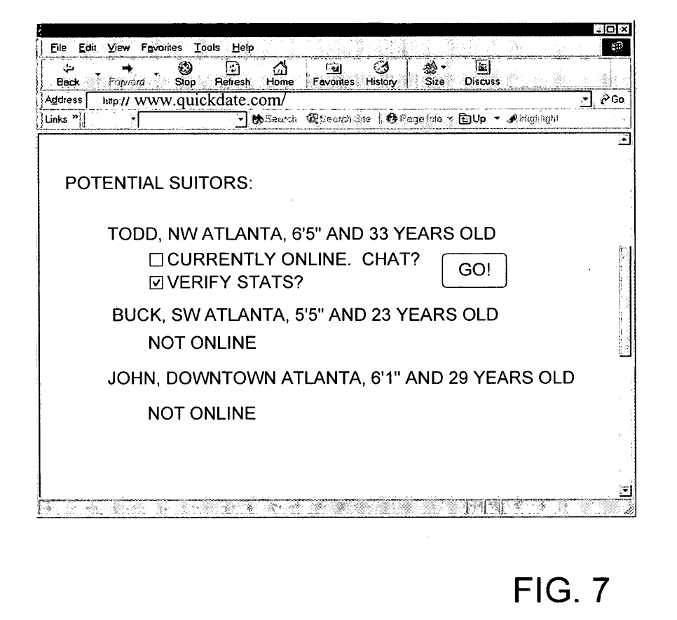

The identification service of the present disclosure is useful in providing identification and biographical information about another person in a variety of contexts. For example, FIG. 7 depicts one possible implementation involving a web dating service. In the example shown, a member of the dating service is browsing entries for other members of the service. The entries include an entry for Todd who is indicated to be currently online and available to chat. However, before the user chooses to chat with Todd, the user selects a checkbox under his entry to verify his stats or the information that Todd has provided about himself, namely that Todd is 6 feet 5 inches tall and 33 years old. Accordingly, the user checks the checkbox and selects the GO! button to send a request to the identification service to provide biographical information about Todd.

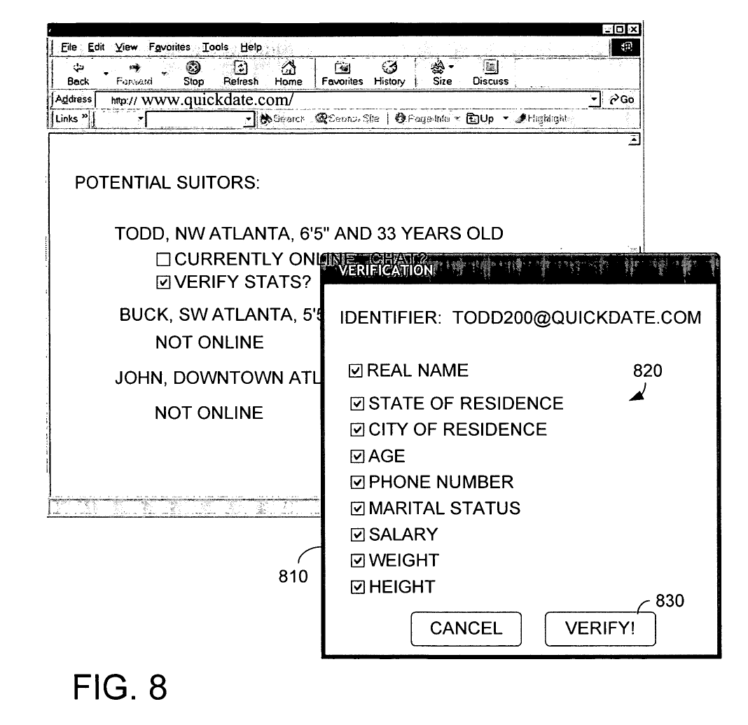

In some embodiments, the user may be provided a new browser window 810 to select the particular items that the user is interested in obtaining about Todd, as shown in FIG. 8. Here, the user checks each of the available items 820, which include Todd's real name, state of residence, city of residence, age, phone number, marital status, his salary, weight, and height. By selecting the VERIFY! button 830, a request is sent to Todd so that he may grant or deny permission to have the checked items released to the user. In the example shown, Todd has been registered a user-ID for the dating service which is “Todd200K@quickdate.com.” Therefore, the request may be sent to this address within the dating service of which Todd may be able to receive online messages. Alternatively, the dating service may also have an instant messaging identifier where the request may be addressed. Regardless, after Todd provides his permission on one or more of the items, the identification service provides the authorized items to the user.

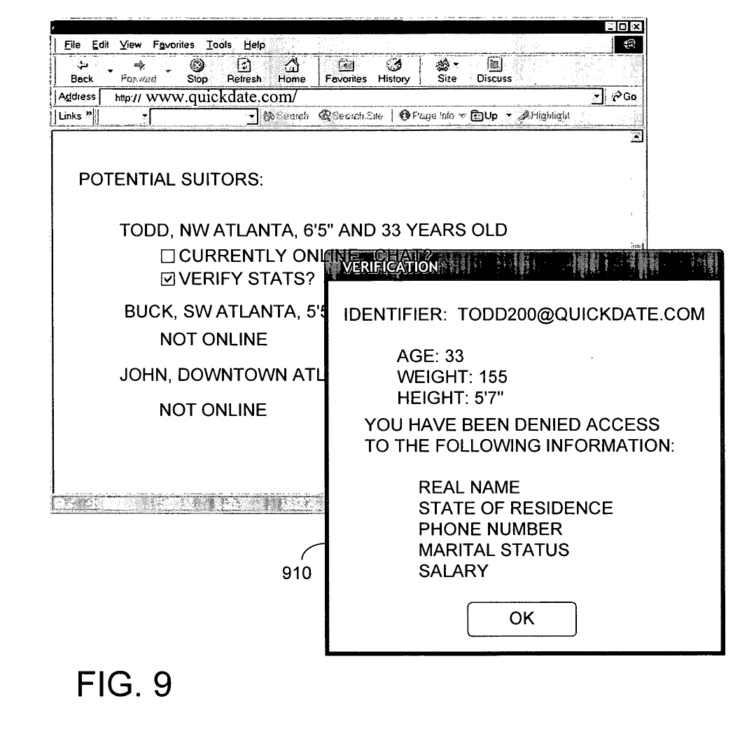

In the example shown in FIG. 9, Todd has only authorized for his age, height, and weight to be released and provided to the user. The response received by the user, in one embodiment, is as shown. Here, a new browser window 910 is launched from the dating service web site with Todd's personal information provided by the identification service. As shown, Todd's verified height (5′7″) is not the height that he provided on the dating service (6′5″).

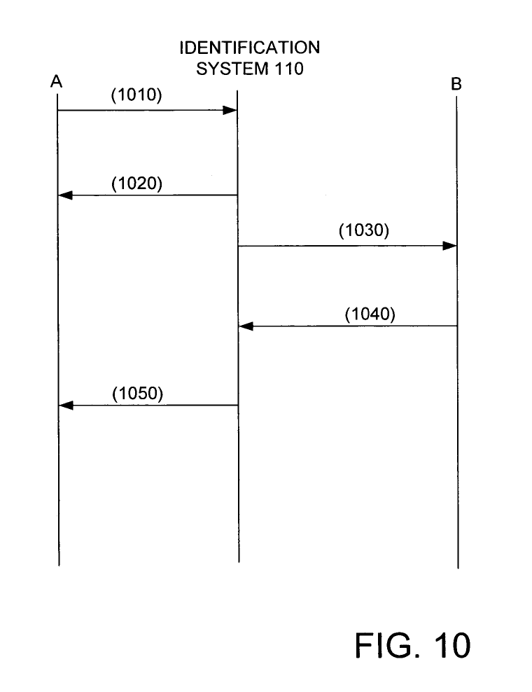

Next, FIG. 10 is a diagram of a flow of interactions between the identification server and database system 110 and client devices of participating users or entities according to an exemplary embodiment. First, an entity A from a client device A (such as client device 130 or 140) requests (1010) the identity of an entity B from the identification server and database system 110. In response, the identification server and database system 110 determines if entity A is allowed to access information of entity B. If entity A is designated within access controls as being allowed to access identification information of entity B, the identification information of entity B is returned (1020) to entity A. If entity A is not allowed to access identification information of entity B, then entity B is prompted (1030) to allow/disallow identity information to entity A and choose what information is accessible. For example, a prompt may ask entity B to allow for a valid e-mail address to be provided to entity A. Further, a prompt may ask entity B to allow for a correct shipping address to be provided to entity A.

If entity B provides (1040) provides authorization to the identification server and database system 110 to release the requested information, then the requested information is provided (1050) to entity A.

The identification service of one or more embodiments may be used in identifying any type of web application or web transaction or computing network situation where both entities have access to the identification service. For example, with a blogging context, a publisher of a web log or blog may desire only a certain group of persons to access a blog. Thus, the publisher may use the identification service to identify users that are desired to access the blog before rendering the blog to a requesting user.

As previously suggested, authorization provided by a member of the identification service may be provided in a work flow or stepped process. For example, a requesting user may request to have access to a member's real name. The member is then prompted to provide permission for this request, and the member responds by granting permission to the identification service. Next, the requesting user requests to have access to the member's state of residence and the member may provide permission for this request to be granted by the identification service. Then, the requesting user requests to have access to the member's street address. At this point, the member denies permission to having this information released to the requesting user.

Accordingly, a member of the identification service may provide levels of access to personal information. This type of approach could be implemented within a chat session within a chat room, for example, while an ongoing communication is occurring.

In one context, the identification service may also be used with a portal service. The portal service can integrate with the identification server and database system 110 and use it to verify that a user is providing a real e-mail address before providing access to the portal service. Also, in a customer relations management context, a user maybe chatting with a customer service agent for a company and the identification service is used to verify that the user is an actual customer of the company.

In another context, a user may be attempting to purchase a product over the Internet via a web site, where the user is in the midst of an electronic chat session with a sales associate for the web site. The sales associate may use the identification service to verify the user before allowing the sales transaction to proceed.

More than just creating an account to an Internet forum or service and creating an association between a person and an account (having a screen name or user ID, for example), the use of identification services allows knowledge of a person and affirmation that the person is who that person purports to be. By verifying beyond a persona presented by a person in a communication or in unverified information presented in an account at a web site or an instant messaging service, a context of a person may be obtained from a reliable source beyond that perpetuated by person in anonymous forms of communication.

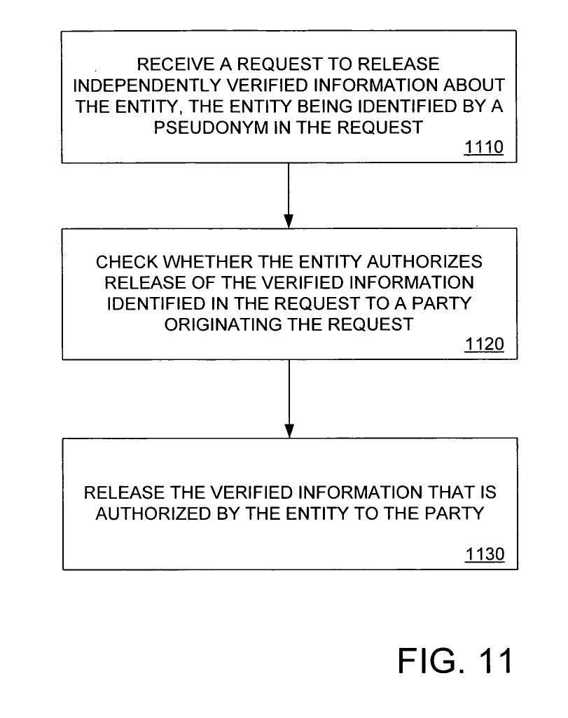

FIG. 11 is a flow chart describing one embodiment of a method for verifying information about an entity. The method begins with the step of receiving (1110) a request to release independently verified information about the entity, the entity being identified by a pseudonym in the request. Whether the entity authorizes release of the verified information identified in the request to a party originating the request is checked (1120) and the verified information that is authorized by the entity is released (1130) to the party.

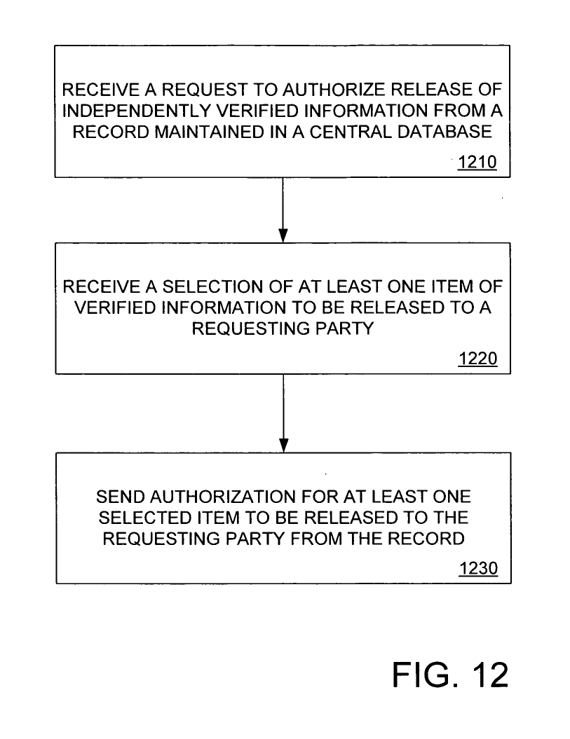

Next, FIG. 12 is a flow chart describing another embodiment of a method for verifying information about an entity. The method begins with the step of receiving (1210) a request to authorize release of independently verified information from a record maintained in a central database. Further, a selection of at least one item of verified information to be released to a requesting party is received (1220). Accordingly, authorization is sent (1230) for at least one selected item to be released to the requesting party from the record.

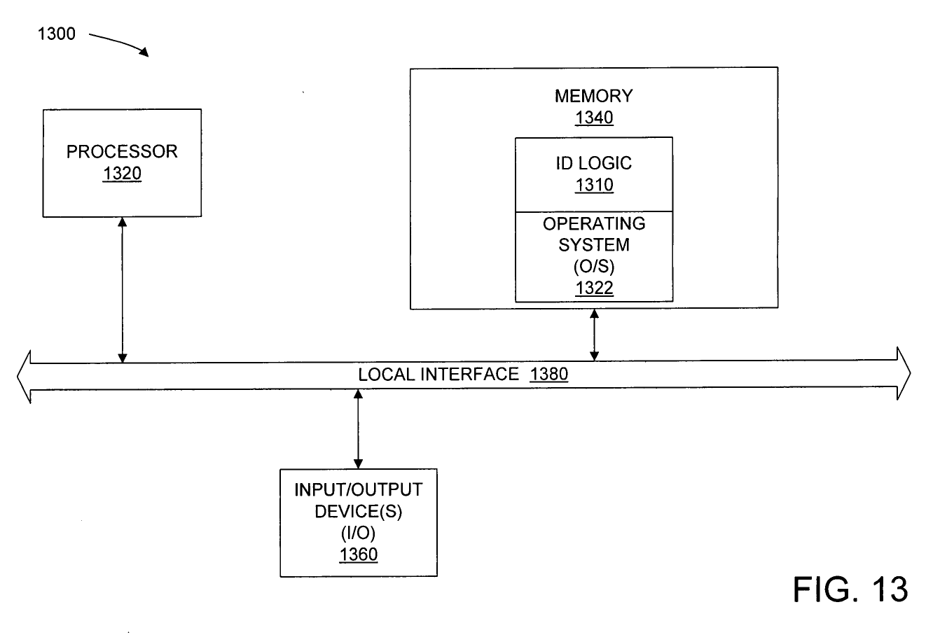

Embodiments of the present disclosure can be implemented in hardware, software, firmware, or a combination thereof. Logic components of the identification system 100 may be implemented in software, as an executable program, and may be executed by a server, special, or general purpose digital computer, workstation, minicomputer, or mainframe computer. An example of a computer that can implement logical components of the identification system 100 of the present disclosure is shown in FIG. 13 as computer 1300. In FIG. 13, the identification system logic (“ID Logic”) denoted by reference numeral 1310.

According to an exemplary embodiment, in terms of hardware architecture, as shown in FIG. 13, the computer 1300 includes a processor 1320, memory 1340, and one or more input and/or output (I/O) devices 1360 (or peripherals) that are communicatively coupled via a local interface 1380. The local interface 1380 can be, for example but not limited to, one or more buses or other wired or wireless connections, as is known in the art. The, the local interface may include address, control, and/or data connections to enable appropriate communications among the aforementioned components.

The processor 1320 is a hardware device for executing software, particularly that stored in memory 1340. The memory 1340 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 1340 may incorporate electronic, magnetic, optical, and/or other types of storage media. Note that the memory 1340 can have a distributed architecture, where various components are situated remote from one another, but can be accessed by the processor 1320.

The software in memory 1340 may include one or more separate programs, each of which comprises an ordered listing of executable instructions for implementing logical functions. In the example of FIG. 13, the software in the memory 1340 includes the identification system logic (ID Logic) in accordance with the present disclosure and a suitable operating system (O/S) 1322. The operating system 1322 controls the execution of other computer programs and provides scheduling, input-output control, file and data management, memory management, and communication control and related services.

The I/O devices 1360 may include input devices, for example but not limited to, a keyboard, mouse, scanner, microphone, etc. Furthermore, the I/O devices 1360 may also include output devices, for example but not limited to, a printer, display, etc. Finally, the I/O devices 1360 may further include devices that communicate both inputs and outputs, for instance but not limited to, a modulator/demodulator (modem;

for accessing another device, system, or network), a radio frequency (RF) or other transceiver, a telephonic interface, a bridge, a router, etc.

When components of the identification system 100 are implemented in software, the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method.

One or more components of the identification system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

In an alternative embodiment, where one or more components of the identification system are implemented in hardware, the component(s) can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments are merely possible examples of implementations, merely set forth for a clear understanding of the principles of the disclosure. Many variations and modifications may be made to the above-described embodiment(s) without departing substantially from the spirit and principles of the present disclosure. All such modifications and variations are intended to be included herein within the scope of this disclosure.

Therefore, having thus described the invention, at least the following is claimed:

1. A method for verifying information about an entity, comprising:
receiving a request to release independently verified information about the entity, the entity being identified by a pseudonym in the request;
checking whether the entity authorizes release of the verified information identified in the request to a party originating the request; and
if the entity authorizes release of the verified information identified in the request to the party originating the request, releasing the verified information to the party.

2. The method of claim 1, wherein the request is in the form of an instant message.

3. The method of claim 2, further comprising:
generating the request from an instant message chat interface.

4. The method of claim 1, further comprising:
denying the request if the entity is not currently present on an instant messaging service and is unable to currently authorize the request.

5. The method of claim 1, further comprising:
prompting the party to request at least one item of verified information to be retrieved about the entity.

6. The method of claim 1, wherein the party predesignates at least one entity that is authorized to access verified information that is requested by the entity.

7. The method of claim 1, wherein the pseudonym is an instant messaging identifier.

8. The method of claim 1, wherein the entity is a web service.

9. The method of claim 1, wherein the entity is a computer program.

10. A method for verifying information about an entity, comprising:
receiving a request to authorize release of independently verified information from a record maintained in a central database;
receiving a selection of at least one item of verified information to be released to a requesting party; and
sending authorization for at least one selected item to be released to the requesting party from the record.

11. The method of claim 10, further comprising:
receiving a selection of at least one item of verified information to not be released to the requesting party.

12. The method of claim 10, further comprising:
prompting the entity to select at least one item of verified information to be released to the requesting party.

13. The method of claim 10, further comprising the step of:
prompting the entity to request a verification of information about the requesting party before authorization release of verified information from the record of the entity to the requesting party.

14. The method of claim 10, wherein the request is received as an instant message.

15. A computer readable medium having a computer program for verifying information about an entity, the program having instructions for performing the steps of:
receiving a request to release independently verified information about the entity, the entity being identified by a pseudonym in the request;
checking whether the entity authorizes release of the verified information identified in the request to a party originating the request; and
releasing the verified information that is authorized by the entity to the party.

16. The computer readable medium of claim 15, the program further comprising:
receiving a selection of at least one item of verified information to not be released to the requesting party.

17. The computer readable medium of claim 16, the program further comprising:
generating the request from an instant message chat interface.

18. The computer readable medium of claim 15, the program further comprising the step of:
denying the request if the entity is not currently present on an instant messaging service and is unable to currently authorize the request.

19. The computer readable medium of claim 15, the program further comprising the step of:
prompting the party to request at least one item of verified information to be retrieved about the entity.

20. The computer readable medium of claim 19, wherein the entity is a computer program that imitates a human person.
